(19) United States
(12) Patent Application Publication
(10) Pub. No.: US 2022/0078297 A1
(43) Pub. Date: Mar. 10, 2022

(54) AUTOMATIC IDENTIFICATION OF SUB-ASSEMBLIES IN A SYSTEM

(71) Applicant: Hewlett-Packard Development Company, L.P., Spring, TX (US)

(72) Inventors: Niv Shem Tov, Ness Ziona (IL); Dan Kessler, Ness Ziona (IL); Amit Levi, Ness Ziona (IL); Uri Tovim, Ness Ziona (IL)

(73) Assignee: Hewlett-Packard Development Company, L.P., Spring, TX (US)

(21) Appl. No.: 17/418,012

(22) PCT Filed: Apr. 11, 2019
(86) PCT No.: PCT/US2019/027045

§ 371 Date: Jun. 24, 2021

(51) Int. Cl. H04N 1/00; G06F 3/12; H04W 4/80

(52) U.S. Cl. CPC H04N 1/00538; H04W 4/80; G06F 3/1206; G06F 3/1229

(57) ABSTRACT

Example implementations relate to automatically identifying sub-assemblies in a printer system. One example implementation signals a unique connector identifier to a sub-assembly coupled to the printer system. The unique connector identifier is associated with a location within the printer system. The signalled unique connector identifier and a functional identifier associated with the sub-assembly are transmitted from the sub-assembly in order to associate the sub-assembly with the location within the printer system.

### BACKGROUND

Printer systems include many parts or sub-assemblies, some of which may be removable to allow for replacement or upgrading. These sub-assemblies may be designed to cooperate with other sub-assemblies within the printer system in order to perform various functions associated with printing, such as storing and transporting printing fluid, cooling, actuating mechanical movements and monitoring operational parameters. A controller of the printer system communicates with the sub-assemblies to monitor and control their operation in order to properly coordinate overall operation of the printer system. The printer system may include inkjet or laser printers for personal and commercial use, or digital printing press systems for high volume and/or high-quality printing applications.

### BRIEF DESCRIPTION OF THE DRAWINGS

Various features of the present disclosure will be apparent from the detailed description which follows, taken in conjunction with the accompanying drawings, which together illustrate features of the present disclosure, and wherein:

FIG. 1 is a schematic of an example printer system;

FIG. 2 is a block diagram of an example connector for a printer system;

FIG. 3 is an electrical schematic of the connector of FIG. 2;

FIG. 4 is a schematic of an example sub-assembly and an example controller for a printer system;

FIG. 5 is a flow chart for operating an example sub-assembly for a printer system;

FIG. 6 is a flow chart for operating an example controller for a printer system; and

FIG. 7 is a flow chart for operating an example connector for a printer system.

### DETAILED DESCRIPTION

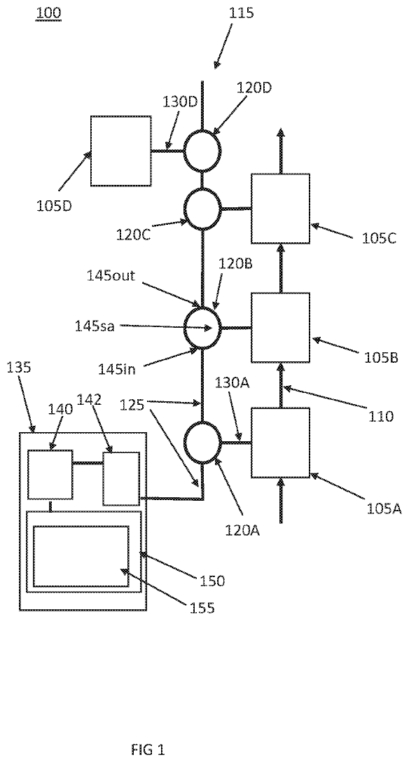

FIG. 1 illustrates a printer system according to an example. The printer system 100 comprises a number of sub-assemblies or parts 105A-105D which are automatically identifiable by the printer system. These automatically identifiable sub-assemblies will typically be user removable and may include pumps, valves, motors, fans, printing fluid reservoirs, actuators and sensors, micro switches and gauges. The automatically identifiable sub-assemblies may cooperate with other sub-assemblies, including those which are not automatically identifiable, and which may be fixed or non-removable sub-assemblies such as pipes, electrical buses, mounting structures, drive trains and rollers.

Some example sub-assemblies 105 may be coupled to each other in order to provide a fluid pathway for printing fluid, for example a printing fluid pump 105B has an input port coupled to an inlet flow valve 105A and an output port coupled to an outlet flow valve 105C. Some example sub-assemblies may cooperate with other sub-assemblies in functional ways which do not involve a common fluid pathway but may still involve locational proximity, for example a fan 105D may be located adjacent the pump 105B to provide cooling.

The sub-assemblies 105 may be related to the printer system 100 and each other by location within the printer system. For example, the inlet flow valve 105A may be located adjacent the input port of the pump 105B, and the outlet flow valve 105C may be located adjacent the output port of the pump 1056. This may allow the printer system to determine if a sub-assembly 105 has been installed at an incorrect location, missing sub-assemblies, as well as to correctly control operation of the printer system 100.

The printer system 100 also comprises a communications bus or system 115 coupled to the controller 135. The communications system 115 comprises a number of connectors 120A-120D connected to each other and the controller by suitable cable runs 125. These connectors may be identical. Each connector 120 is associated with a location within the printer system 100 and is adapted to connect to an automatically identifiable sub-assembly 105A-105D, for example in use connector 120A is connected to sub-assembly 105A, and connector 120B is connected to sub-assembly 105B.

In this example, each connector 120 has three connections: an input connection 145in connected to a cable 125 from another connector 120 or the controller 135; an output connection 145out connected to a cable to another connector 120; a sub-assembly connection 145sa connected to a cable to a sub-assembly 105. The connections 145 may be in the form of a plug and socket, for example M12 electrical connectors, a serial connection architecture using cables between the connectors 120 and the controller 135, and individual spur cable connections from each connector 120 to its respective sub-assembly 105. Alternatively, a soldered cable may be provided as one of the connections 145in. In a further alternative, the connectors 120 may be coupled to the controller 135 and/or sub-assembly using a wireless connection such as Bluetooth™ or WiFi™.

The communications network 115 allows the sub-assemblies to identify themselves to the controller 135, and also to send and receive control signals such as monitoring or actuator signals. In the example the communication system comprises a serial multi-drop shared line connected in a daisy-chain arrangement and operates using a multi-user access system such CAN-bus or RS485 for example. However other communications protocols and connection architectures may alternatively be used.

The controller 135 comprises a communications module 142 which enables communications with the sub-assemblies 105 according to the implemented communications protocol. The controller also comprises a processor 140 and memory storage 150 which comprises instructions 155 to implement a method of automatic identification according to an example. The controller 135 monitors signals from the sub-assemblies 105, for example input and output pump flow levels, and also controls some sub-assemblies such as switching on/off a fan to control cooling or opening or closing a valve to change a fluid pathway. These signals are passed to/from the sub-assemblies 105 via their respective connectors 120.

Each connector 120 is associated with a unique connector identifier which corresponds with a location within the printer system. This unique connector identifier is used by the sub-assembly 105 connected to that connector 120 to signal its location to the controller 135. The sub-assembly also signals its type and/or function to the controller, for example using a function identifier. Using a unique connector identifier and the function identifier, the controller 135 can then associate the corresponding sub-assembly 105 with a particular location within the printer system 100.

By pairing unique connector identifiers with function identifiers, the controller 135 can build a map of the functionality of the printer system and the parts within it. This information can be used to determine whether a sub-assembly has been incorrectly installed, for example that a shut-off valve rather than flow valve has been installed before a pump (at the location of 105A). The controller 135 will also have information to correctly configure operation of the printer system, for example the function identifier will indicate the capacity of the pump 105B and therefore the range of acceptable input flow rates for flow valve 105A.

More generally, this example provides flexibility to accommodate changes in the printer system by automatically identifying newly installed sub-assemblies which may enhance or extend the printing functionality of the printer system 100. The printer system may be scaled up without changing the system's infrastructure, for example without the need to add new cable runs from a new sub-assembly to the controller. Automatic identification of sub-assemblies also reduces manual installation and commissioning work and also reduces the chance of incorrect identification due to manual errors. The hardware used by each sub-assembly for automatic identification is the same, leading to improved economy of scale and standardization of parts.

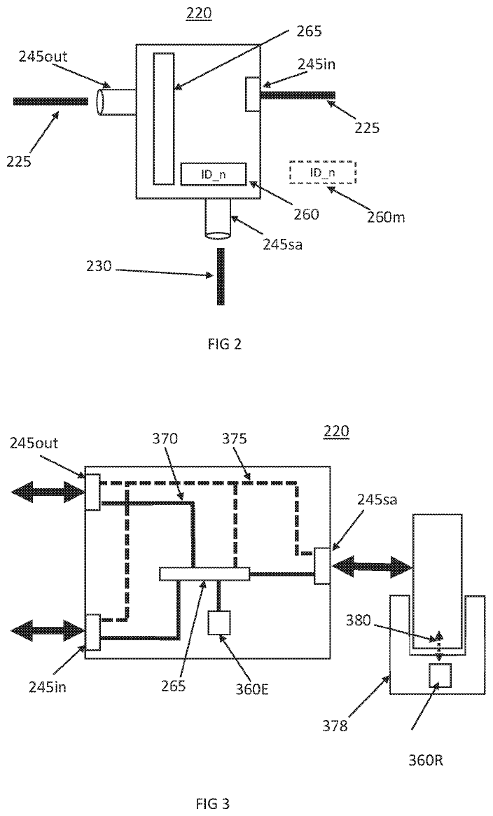

FIGS. 2 and 3 illustrate schematics of a connector according to an example. The connector 220 may comprise an M12 output socket 245 out to which an M12 plug on a cable 225 may be connected. The cable 225 may be connected to another connector 220. The reference here to “input” and “output” is merely a convention used to show the direction and progression of a daisy-chain connected architecture, and in fact communications will pass in both directions. Also, whilst M12 connectors are a commonly used industrial connector type, other suitable connector arrangements may alternatively be used, for example D-SUB or RJ45. The connector 220 comprises a soldered connection 245in to another length of cable 225 connected to another connector 220 or a controller. The connector 220 also comprises another M12 output socket 245sa to which an M12 plug on a cable 230 may be connected. The cable 230 may be connected to a sub-assembly. In addition to a communications line, the cables 225, 230 may also comprise a powerline in order to power the connectors 220 and any coupled sub-assemblies.

The connector 220 has a circuit board 265 which comprises various electrical and electronic modules to implement the connectors functionality. 265 implements short circuits between 245out, 245in, 245sa for the mentioned communications and power (24v/48v) distribution. The circuit board 265 may also provide other functionality such as an LED indicating the connector 220 is connected to and powering a sub-assembly.

The connector 220 also comprises a connector identifier module 260 containing a unique connector identifier ID_n, that may be associated by the controller 135 with a particular location within the printer system 100. The module 260 may be a non-volatile memory such as an EEPROM that is connected to the circuit board in order to provide the identifier ID_n to a sub-assembling in response to the sub-assembly connecting to the connector 220.

Alternatively (or additionally), the module 260 may be a near field communications (NFC) or RFID tag that responds with the identifier ID_n when illuminated by a suitable probing signal from an NFC transponder attached to a nearby sub-assembly. NFC communications are near-field or short range, and therefore communication will be limited to nearby NFC transceivers. Some NFC standards mandate a distance of less than 4 cm to for communication between NFC transceivers. This limits communication to sub-assemblies that can be connected to the connector via the connecting cable 230. For example, a sub-assembly containing an NFC transponder may be arranged to periodically transmit an NFC probe signal. When the sub-assembly is installed in the printer system, its transponder will be within range of the corresponding connector 220 so that upon the next probe signal, the connector's unique connector identifier will be returned by the NFC tag.

In an example, a connector identifier module 260m may be positioned adjacent to the connector 220, for example fixed to mechanical structures adjacent the connector 220 and/or a mechanical coupling arrangement for securing the sub-assembly. The connector identifier module 260m is positioned so that it is close enough to the sub-assembly when installed that the stored unique connector identifier may be signaled. By using a connector identifier modules 260m positioned outside of but adjacent a connector, the connectors 220 used in the system may each be identical and easily replaced or moved as needed. If the connector 220 and/or connector identifier modules 260, 260m are relocated, the location associated with their associated unique connector identifier can by updated in the controller.

FIG. 3 shows the internal electrical connections of the connector 220. The communications lines 370 connect the circuit board 265 with the two daisy-chain connections 245in and 245out, as well as the sub-assembly connection 245sa. An EEPROM 260E is also connected to the circuit board 265 and may be interrogated by a sub-assembly to determine the unique connector identifier ID_n for transmitting to a connected sub-assembly. An NFC tag 360R is also shown and is powered directly by a probing signal 380 from a nearby NFC transponder. This will therefore be limited to occur when the sub-assembly is very near to the connector (eg less than 4 cm), and in practice when it is properly installed and connected to the connector. The NFC tag 360R is located within a sub-assembly mechanical coupling arrangement 378. The NFC tag 360R also responds with the connector's unique connector identifier ID_n. Providing this identifier through two different communications channels and positioned within two different structures (the connector 220 and the mechanical structure 378 provides greater confidence that the sub-assembly is associated with the correct connector 220 and location within the system.

The cables 225 of the communications network 115 also provide a powerline which is connected internally 375 to the circuit board and the sub-assembly connection 245sa. The double arrowed lines at each of the connections 245in, 245out, 245sa indicate that communications and power travel in both directions.

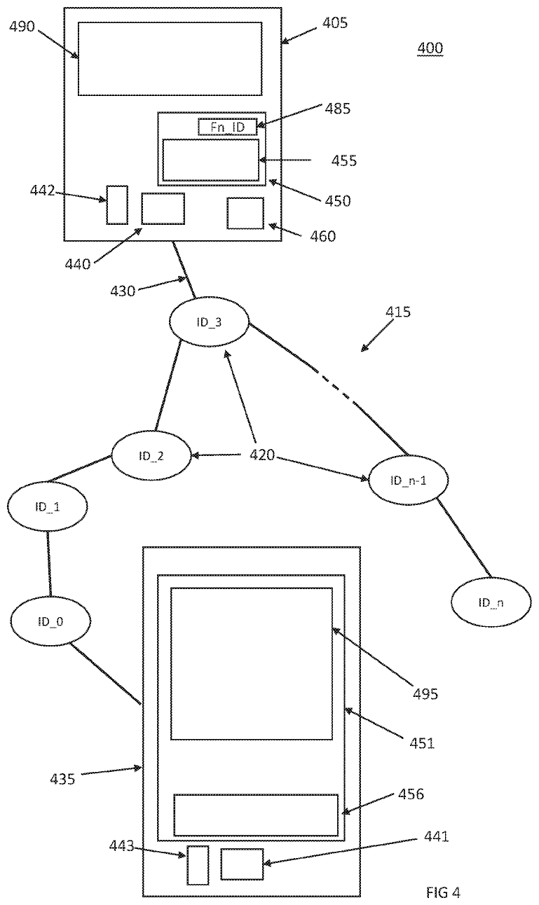

FIG. 4 illustrates a schematic of a sub-assembly and a controller according to an example. These may be implemented in a printer system 400 in which the sub-assembly 405 is coupled via a communications system 415 to the controller 435. The communications system 415 comprises a number of connectors 420 which are associated with predetermined locations within a printer system. Each connector comprises a unique connector identifier ID_0-ID_n, with the associated location predetermined in the controller 435. The sub-assembly is connected to one of the connectors (ID_3) by a cable 430, for example using an M12 plug and socket connection.

The sub-assembly 405 comprises a communications module 442 to communicate with the controller 435 using a predetermined protocol. The sub-assembly 405 also comprises a processor 440 and memory 450 and may optionally include an NFC transponder 460 for integrating NFC tags on the connectors 420 if this implementation is used, in order to determine the unique connector identifier (ID_3) of the adjacent or connected connector 420. Alternatively (or additionally), the unique connector identifier (ID_3) may be transmitted from the connector 420 over the connecting cable 430. This identifier ID_3 may be used to generate an automatic identification signal from the sub-assembly 405 to the controller 435. The memory 450 comprises instructions 455 for controlling the automatic identification signaling, and also contains a function identifier 485 associated with the sub-assembly.

The sub-assembly comprises a functional element 490 which is adapted to performing a printing function for the printer system 400. The functional element may be a fan, pump, valve, fluid printing reservoir, actuator or sensor for example. A function identifier 485 is associated with the functional element and may be a part number or a predetermined functional indicator such as a number representing its function and which the controller 435 can interpret.

The sub-assembly is arranged to determine the functional identifier and the unique connector identifier ID_3 from the connected connector 420, and to transmit both of these to the controller 435. The controller 435 is able to use this paired information to determine what functionality or functional element is located at the location associated with the connector 420. The same type of sub-assembly may be located at two or more different locations within the printing system.

The controller 435 comprises a communications module 443 to communicate with the sub-assemblies 405 using a predetermined protocol. The controller 435 also comprises a processor 441 and memory 451 which contains instructions for operating the controller 456 to automatically identify sub-assemblies connected to the printer system 400. The memory 451 also comprises printer system configuration data 495 which includes associations between sub-assemblies identified by respective functional identifiers and unique connector identifiers. Each sub-assembly automatically identifies itself by forwarding a functional identifier and a unique connector identifier so that the controller can determine its location and functional abilities, for example pump at location X and flow rate valve at location Y. The controller 435 can then determine if the sub-assembly is in an appropriate location and issue an alert if it is not. Control messages from the controller to a particular sub-assembly can also be correctly directly by addressing these to the corresponding connector. Similarly, the controller 435 can retrieve monitoring signals from a sub-assembly identified by its unique connector identifier. In this way, the controller can coordinate operation of the various sub-assembles to optimally control the printer system.

FIG. 5 is a flow chart of a method of operating a sub-assembly, which may be implemented for example using the processor 440 and instructions 455 of FIG. 4. The sub-assembly initially receives a unique connector identifier from a connector at 505. This may be achieved by periodically transmitting an NFC signal and listening for a response from a nearby connector. Additionally, or alternatively, the unique connector identifier may be received from the connector via a connected cable, for example by using a communications line of the cable to interrogate an EEPROM. Other lines of the cable may be used to communicate with the controller using CAN-bus or RS485 communications protocols for example.

The sub-assembly then determines a functional identifier at 510. This may be an identifier stored locally and which corresponds to a part number or a predetermined reference to the functional capabilities of the sub-assembly. The sub-assembly then transmits both the functional identifier and the unique connector identifier it retrieved from the connector at 515. These identifiers are transmitted over the communications network to the controller using whichever communications protocol that is implemented.

The sub-assembly may then transmit feedback signals to the controller, for example monitoring signals such as the current flow rate through the sub-assembly. These signals may be transmitted together with the unique connector identifier, or may be logically associated with the connector by the communications protocol. The sub-assembly may also receive and act upon control signals addressed to and received by the sub-assembly.

FIG. 6 is a flow chart of a method of operating a controller, which may be implemented for example using the processor 441 and instructions 456 of FIG. 4. The controller receives a unique connector identifier and function identifier from a sub-assembly at 605. This is received over the communications network using a protocol like CAN-bus. The controller then associates the sub-assembly with a location corresponding to the connector identified by the unique connector identifier at 610. This may be achieved using a database or table to logically associate these two entities. The controller may also associate the sub-assembly with functionality determined from the functional identifier, and this may be checked to determine if this is appropriate for the associated location for validation purposes. If the sub-assembly is determined to be at a wrong location, and alert may be provided to a user so that the sub-assembly can be removed and re-installed at a more appropriate location/connector.

The controller may then transmit control signals to the sub-assembly, for example to cause it to perform a certain action such as switching on or off. The controller may also receive feedback signals from the sub-assembly, for example its current operational status.

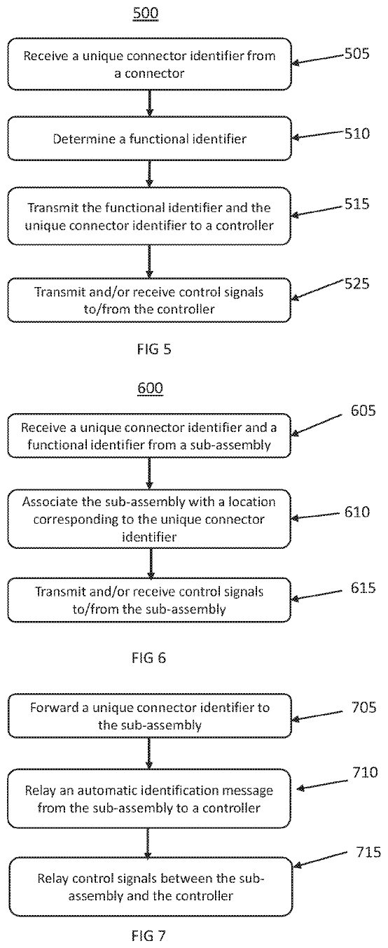

FIG. 7 is a flow chart of a method of operating a connector, which may be implemented for example using the processor 140 and instructions 155 of FIG. 1. The connector is arranged to forward a unique connector identifier to a sub-assembly at 705. As previously discussed, this may be provided from an EEPROM, NFC tag or other mechanism to a sub-assembly coupled to the connector. The connector then relays an automatic identification message from the sub-assembly to the controller at 710. The automatic identification message comprises the unique connector identifier forwarded by the connector together a functional identifier associated with the sub-assembly. The connector may then relay control messages between the sub-assembly and the controller at 715.

The printer system may be a digital printing press or a domestic or commercial inkjet or laser printer for example. In other examples the sub-assemblies may belong to any larger system, including industrial systems with sensors, actuators and removable other parts.

The preceding description has been presented to illustrate and describe examples of the principles described. This description is not intended to be exhaustive or to limit these principles to any precise form disclosed. Many modifications and variations are possible in light of the above teaching. It is to be understood that any feature described in relation to any one example may be used alone, or in combination with other features described, and may also be used in combination with any features of any other of the examples, or any combination of any other of the examples.

What is claimed is:

1. A system comprising:
a number of sub-assemblies having a functional identifier;
a communications network coupled to a controller, the communications network having a plurality of connectors each for connecting to a said sub-assembly,
a connector identifier module associated with each connector and arranged to signal a unique connector identifier to a sub-assembly connected to the connector;
wherein the or each sub-assembly is arranged to transmit the unique connector identifier signalled from the respective connector identifier module together with a functional identifier associated with the sub-assembly to the controller.

2. The system of claim 1, wherein each unique connector identifier is associated with a location within the system.

3. The system of claim 1, wherein each functional identifier corresponds to a functional capability of the associated sub-assembly.

4. The system of claim 1, wherein the unique connector identifier is stored in non-volatile memory in the connector and accessible to the sub-assembly when connected to the connector.

5. The system of claim 1, wherein the unique connector identifier is stored in non-volatile memory in the system adjacent the connector and accessible to the sub-assembly when connected to the connector.

6. The system of claim 1, wherein the unique connector identifier is signaled to the sub-assembly from the connector identifier module using near field communications.

7. The system of claim 1, wherein the communications network comprises cables serially connecting each connector to the controller, and cables for connecting each connector to a sub-assembly.

8. The system of claim 1, wherein the controller is arranged to associate the or each sub-assembly with a location in the system using the respective unique connector identifier and functional identifier sent from each sub-assembly.

9. The system of claim 7, wherein the controller is arranged to exchange control signals with the associated sub-assemblies in order to control operation of the printer system.

10. The system of claim 1 wherein the system is a printer system.

11. A sub-assembly for a printer system having a communications network having a plurality of connectors coupled to a controller, the sub-assembly comprising:
a processor and a memory having processor executable instructions and a functional identifier, the instructions arranged to control the processor to:
receive a unique connector identifier from a connector identifier module associated with said connector;
transmit an automatic identification message to the controller using the connector, the message comprising the functional identifier and the received unique connector identifier.

12. The sub-assembly of claim 11, wherein the unique connector identifier is received using a cable connected to the connector or using near field communications.

13. A method of operating a system arranged to couple with a plurality of sub-assemblies; the method comprising:
signalling a unique connector identifier to a said sub-assembly coupled to the system, the unique connector identifier associated with a location within the system;
receiving the signalled unique connector identifier and a functional identifier from a sub-assembly coupled to the system;
associating the sub-assembly with the location within the system using the unique connector identifier and the functional identifier.

14. The method of claim 13, wherein signaling the unique connector identifier to the sub-assembly comprises electrically connecting the sub-assembly to a connector or transmitting the unique connector identifier from the connector using near field communications, wherein the connector is associated with a location within the printer system.

15. The method of claim 13, comprising indicating whether the sub-assembly belongs at the location.
